(19) United States
(12) Patent Application Publication
(10) Pub. No.: US 2016/0217432 A1
(43) Pub. Date: Jul. 28, 2016

(54) Digital Calendar Systems and Methods

(71) Applicant: MEEKAN SOLUTIONS LTD., Tal-Aviv (IL)

(72) Inventors: Eyal YAVOR, Tel Aviv (IL); Lior Yavor, Tel Aviv (IL); Matty Mariansky, Tel Aviv (IL)

(21) Appl. No.: 15/023,534

(22) PCT Filed: Jul. 6, 2014
(86) PCT No.: PCT/IB2014/062898

§ 371 Date: Mar. 21, 2016

Related U.S. Application Data
(60) Provisional application No. 61/880,940, filed on Sep. 22, 2013.

(51) Int. Cl. G06Q 10/10; G01C 21/34

(52) U.S. Cl. CPC G06Q 10/1095; G01C 21/3492

(57) ABSTRACT

A system including: (a) a calendar database adapted to receive calendar events including location information for specified time slots from subscribers; (b) a query engine adapted to receive a meeting request including a time definition, a location definition and a list of invitees including subscribers; and (c) a location module adapted to consider travel times of one or more invitees to and/or from locations of existing calendar events to the location; and (d) a list generator adapted to generate a list of time slots which allow invitees sufficient time to travel to/from adjacent calendar events.

### RELATED APPLICATION

This application claims is a national stage application under 35 U.S.C. §371(c) of PCT/IB2014/062898 entitled “Digital Calendars Systems and Methods” which claimed the benefit of 35 USC §119 (e) from provisional patent application U.S. 61,880,940 filed on Sep. 22, 2013 by Eyal YAVOR et al. and entitled “METHOD AND SYSTEM FOR CALENDARING EVENTS”; each of which is fully incorporated herein by reference.

### FIELD OF THE INVENTION

Many described embodiments are in the field of electronic calendars.

### BACKGROUND OF THE INVENTION

Many people use electronic (digital) calendar platforms such as those provided by GOOGLE, MICROSOFT, and APPLE to manage their schedules.

As with conventional paper calendars, it frequently occurs that an event must be re-scheduled before it actually occurs.

Factors such as the number of participants and temporal proximity to the originally scheduled time/date contribute to an increase in the difficulty of re-scheduling an event in both conventional paper calendars and electronic (digital) calendar systems.

### SUMMARY OF THE INVENTION

One aspect of some embodiments of the invention relates to cross platform sharing of free/busy status among individuals. In some exemplary embodiments of the invention, this cross platform sharing is achieved without installation of any software on user client devices belonging to the individuals. Alternatively or additionally, in some embodiments a calendar management server receives free/busy status from all subscribers wishing to participate in the cross platform sharing. Alternatively or additionally, in some embodiments the calendar management server receives only free/busy status from un-registered subscribers. Alternatively or additionally, in some embodiments the calendar server receives free/busy status and additional data from registered subscribers. In some embodiments, registered subscribers install software on their user client devices to facilitate provision of this additional data. According to various exemplary embodiments of the invention the additional data includes location and/or rank and/or organizational affiliation and/or personal preferences.

In some embodiments, a meeting organizer submits a list of invitees using different calendar platforms and receives an initial list of potential time slots at which all the invitees are available. In some embodiments, if there are no time slots at which all the invitees are available the initial list of potential time slots indicates how many conflicts there are for each time block and/or which invitees have conflicts for each time block.

Another aspect of some embodiments of the invention relates to considering a user's location at a first time in evaluating that user's availability for an event at another time in a different location. In some embodiments, a calendar server includes a travel time estimation module to support this feature.

One aspect of some embodiments of the invention relates to implementation of natural language definitions of acceptable meeting times within a multi-user computerized calendar system. In some embodiments, implementation of natural language definitions of acceptable meeting times contributes to scheduling flexibility. In some embodiments, subscribers implement multi-conditional rules when scheduling a meeting.

Another aspect of some embodiments of the invention relates to “ripple effect” re-scheduling. In ripple effect re-scheduling the meeting organizer cancels a scheduled meeting and selects a new time from the initial list provided by the system when the meeting was initially scheduled. According to these embodiments, meetings which were scheduled by attendees since the original scheduling occurred are automatically rescheduled to accommodate a new time selected by the meeting organizer. In some cases these attendees are organizers of other meetings and a chain reaction is started. In some embodiments, ripple effect re-scheduling is available only for registered subscribers and/or does not affect non-registered subscribers. In some embodiments, non-registered subscribers must provide approval for ripple effect re-scheduling of meetings to which they are invited.

It will be appreciated that the various aspects described above relate to solution of technical problems associated with electronic (digital) scheduling of meetings with invitees using different calendar programs.

Alternatively or additionally, it will be appreciated that the various aspects described above relate to solution of technical problems related to resolving conflicts between meetings arising from re-scheduling.

Alternatively or additionally, it will be appreciated that the various aspects described above relate to solution of technical problems related to insuring that subscribers allow sufficient time to travel between meetings in different locations.

In some exemplary embodiments of the invention there is provided a system including: (a) a calendar database adapted to receive calendar events including location information for specified time slots from subscribers; (b) a query engine adapted to receive a meeting request including a time definition, a location definition and a list of invitees including subscribers; and (c) a location module adapted to consider travel times of one or more invitees to and/or from locations of existing calendar events to the location; and (d) a list generator adapted to generate a list of time slots which allow invitees sufficient time to travel to/from adjacent calendar events.

In some embodiments, the system includes a traffic history database storing average travels speeds on roads as a function of time; and a route planner configured to estimate a fastest travel time for each invitee based upon the time definition and the locations of existing calendar events and the location specified in the meeting request. Alternatively or additionally, in some embodiments the system includes a temporal comparator configured to, for each invitee, calculate the amount of time between the time definition in the meeting request and an adjacent existing calendar event to produce an available travel time estimate; and compare the available travel time estimate to the fastest travel time provided by the route planner and inform the list generator whether the time between the meeting request and the existing calendar event is sufficient or insufficient. Alternatively or additionally, in some embodiments the system includes a current traffic database monitoring average travels speeds on roads; and a warning generator configured to monitor trends in fastest travel time for each invitee based upon current invitee locations and the location and the time definition specified in the meeting request and issue a warning to at least one invitee if it appears that they will have insufficient travel time. Alternatively or additionally, in some embodiments not all of the subscribers use a same electronic calendar platform.

In some exemplary embodiments of the invention there is provided a system including: (a) a calendar database storing free/busy status for time slots in calendars of subscribers using different electronic calendar platforms; and (b) a query engine adapted to receive a meeting request including a time definition and a list of invitees including subscribers using different electronic calendar platforms and provide a sorted list of time slots available for the requested meeting. In some embodiments, the system serves at least some of the subscribers without the at least some of the subscribers installing any software on their user client devices to supplement their electronic calendar platforms. Alternatively or additionally, in some embodiments the system includes a subscription invitation module adapted to identify one or more invitees in the list not among the subscribers and issue a subscription invitation to the one or more invitees in the list not among the subscribers. Alternatively or additionally, in some embodiments the calendar database includes: only free/busy status for time slots in calendars of subscribers that are un-registered; and free/busy status for time slots in calendars and additional data for subscribers that are registered. Alternatively or additionally, in some embodiments the system includes: (a) a calendar database storing free/busy status for time slots in calendars of subscribers; and (b) a query engine adapted to receive a flexible meeting request including a meeting length, starting time range for hours within a day, and time range in days and a list of invitees and provide a sorted list of time slots complying with the request conditions. Alternatively or additionally, in some embodiments the system includes a natural language translator adapted to translate words defining starting time range for hours within a day, and time range in days into numerical values. Alternatively or additionally, in some embodiments the natural language translator accepts an audio input. Alternatively or additionally, in some embodiments the natural language translator accepts a text input. Alternatively or additionally, in some embodiments the system includes a personal preferences database storing scheduling preferences of subscribers, wherein the query engine imposes personal preferences of invitees as additional conditions upon the meeting request. Alternatively or additionally, in some embodiments the personal preferences database is adapted to indicate each personal preference as flexible or inflexible. Alternatively or additionally, in some embodiments the query engine is adapted to accept additional constraints as part of the meeting request. Alternatively or additionally, in some embodiments not all of the invitees use a same electronic calendar platform.

In some exemplary embodiments of the invention there is provided a method including: (a) receiving a cancellation request for a scheduled meeting at a calendar server; (b) presenting a list of proposed times to an organizer of the scheduled meeting with indication of conflicts with other events for each invitee; and (c) receiving a selection of one of the proposed times from the organizer. In some embodiments, the method includes scheduling a new meeting for all invitees according to the selection and notifying any invitees that have a conflict with previously scheduled meeting as a result of the new meeting. Alternatively or additionally, in some embodiments the method includes rescheduling any previously scheduled meeting on the calendar of an invitee which conflicts with the new meeting. Alternatively or additionally, in some embodiments the method includes sending an invitation for a new meeting to all invitees according to the selection and suggesting available alternate meeting times for previously scheduled meetings to any invitees that have a conflict with previously scheduled meeting as a result of the new meeting.

In some exemplary embodiments of the invention there is provided a method including: (a) storing a rule having at least two conditions from a subscriber at a calendar database; (b) comparing proposed meeting times to the rule; and (c) notifying the subscriber if a proposed meeting time violates the rule.

In some exemplary embodiments of the invention there is provided a method including: (a) storing a rule having at least two conditions from a subscriber at a calendar database; and (b) suggesting rescheduling of one or more other meetings when acceptance of a meeting invitation violates the rule.

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

As used herein, the terms “comprising” and “including” or grammatical variants thereof are to be taken as specifying inclusion of the stated features, integers, actions or components without precluding the addition of one or more additional features, integers, actions, components or groups thereof. This term is broader than, and includes the terms “consisting of” and “consisting essentially of” as defined by the Manual of Patent Examination Procedure of the United States Patent and Trademark Office. Thus, any recitation that an embodiment “includes” or “comprises” a feature is a specific statement that sub embodiments “consist essentially of” and/or “consist of” the recited feature.

The phrase “adapted to” as used in this specification and the accompanying claims imposes additional structural limitations on a previously recited component.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

As used in this specification and the accompanying claims the singular forms “a,” “an,” and “the” include also the plural forms, unless the context clearly indicates otherwise

As used in this specification and the accompanying claims the term “if” indicates “when” or “upon” or “in response to determining” or “in response to detecting,” depending on the context Similarly, the phrase “if it is determined” or “if [a stated condition or event] is detected” may be construed to mean “upon determining” or “in response to determining” or “upon detecting (the stated condition or event)” or “in response to detecting (the stated condition or event),” depending on the context.

As used in this specification and the accompanying claims the term “organizer” is used to mean a person issuing a meeting request to one or more invitees through a calendar system.

As used herein, the terms “meeting” indicates a calendar event involving one or more invitees. Single-invitee meetings are entered into a calendar system, for example, when a person plans an activity which they know will not include any other system subscribers (e.g. vacation, medical appointment, family function). Such entries are made, for example, to prevent subsequent addition of conflicting meetings to a subscriber's calendar.

As used in this specification and the accompanying claims the term “invitee” indicates people and/or resources invited to an event, irrespective of whether they have accepted, declined, or not yet responded to the meeting request. According to various exemplary embodiments of the invention invitees can be designated as “required participants” whose attendance meeting organizer has identified as required, irrespective of whether they have accepted, declined, or not yet responded to the invitation and/or “optional participants” whose attendance a meeting organizer has identified as optional, irrespective of whether they have accepted, declined, or not yet responded to the invitation.

As used in this specification and the accompanying claims the term “resource” in the context of invitee indicates a place (e.g. room) or thing (e.g. vehicle, presentation equipment (e.g. projector or large screen) or refreshments) to be associated with a specific meeting. In some embodiments, the resources are finite (e.g. rooms and/or vehicles) and in other embodiments they are virtually unlimited (e.g. refreshments).

Implementation of the method and system according to embodiments of the invention involves performing or completing selected tasks or steps manually, automatically, or a combination thereof. Moreover, according to actual instrumentation and equipment of exemplary embodiments of methods, apparatus and systems of the invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

In order to understand the invention and to see how it may be carried out in practice, embodiments will now be described, by way of non-limiting example only, with reference to the accompanying figures. In the figures, identical and similar structures, elements or parts thereof that appear in more than one figure are generally labeled with the same or similar references in the figures in which they appear.

Dimensions of components and features shown in the figures are chosen primarily for convenience and clarity of presentation and are not necessarily to scale. The attached figures are:

FIG. 1 is a simplified schematic diagram of a calendar system according to some exemplary embodiments of the invention;

FIG. 2 is a simplified schematic diagram of another calendar system according to some exemplary embodiments of the invention;

FIG. 3 is a simplified schematic diagram of still another calendar system according to some exemplary embodiments of the invention;

FIG. 4 is a simplified schematic diagram of yet another calendar system according to some exemplary embodiments of the invention;

FIG. 5 is a simplified flow diagram of a method according to some exemplary embodiments of the invention;

FIG. 6 is a simplified flow diagram of another method according to some exemplary embodiments of the invention;

FIG. 7 is a simplified flow diagram of still another method according to some exemplary embodiments of the invention;

FIG. 8 is a simplified flow diagram of a method according to some exemplary embodiments of the invention; and

FIGS. 9a to 9f depict layouts of exemplary user interfaces for scheduling calendar events according to various exemplary embodiments of the invention.

### DETAILED DESCRIPTION OF EMBODIMENTS

Embodiments of the invention relate to systems and methods for implementation of electronic calendar events among multiple invitees.

Specifically, some embodiments of the invention can be used to facilitate cross platform registration of meetings and/or insure sufficient travel time for each invitee to arrive at a meeting in light of other meetings on their calendar and/or allow a meeting organizer to request a meeting based upon a flexible time definition and/or implement “ripple effect” rescheduling to resolve conflicts between meetings.

The principles and operation of systems and/or methods according to exemplary embodiments of the invention may be better understood with reference to the drawings and accompanying descriptions.

Before explaining at least one embodiment of the invention in detail, it is to be understood that the invention is not limited in its application to the details set forth in the following description and/or examples. The invention is capable of other embodiments or of being practiced or carried out in various ways. Also, it is to be understood that the phraseology and terminology employed herein is for the purpose of description and should not be regarded as limiting.

### Overview

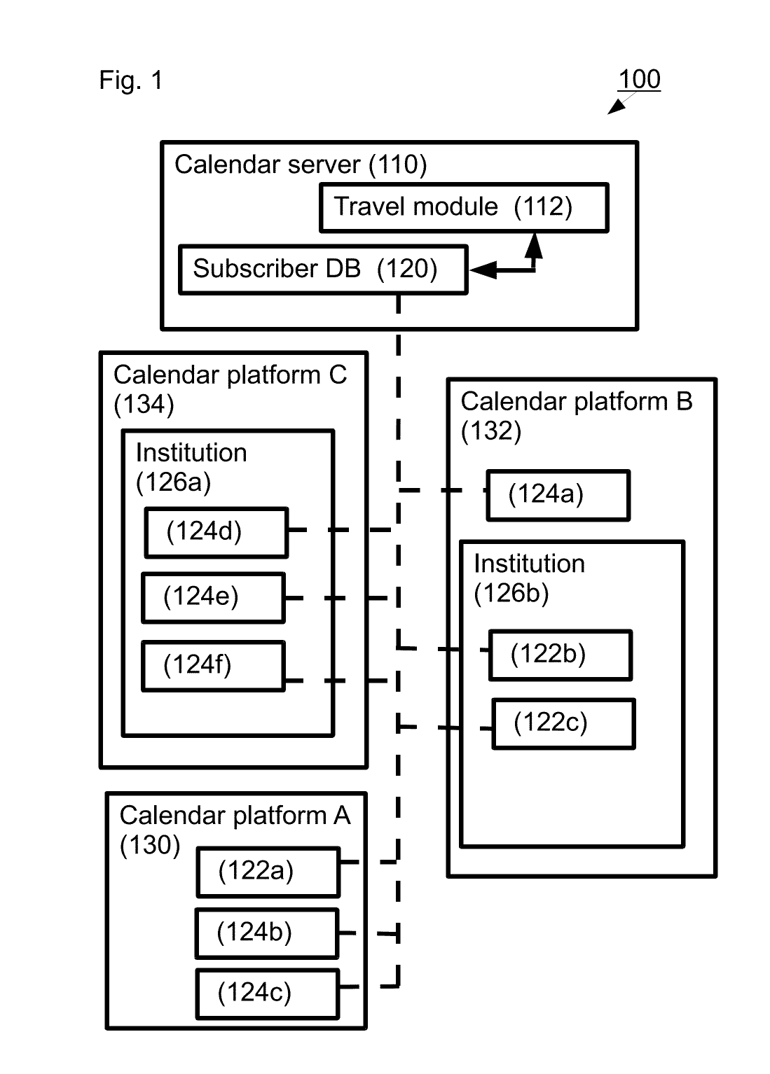

FIG. 1 is a simplified schematic diagram of a calendar system, indicated generally as 100 according to some exemplary embodiments of the invention. Depicted exemplary system 100 features a calendar server 110 hosting a subscriber database 120. In the figure, a small number of subscribers 122a; 122b; 122c and 124a; 124b; 124c; 124d; 124e and 124f are depicted for simplicity of presentation, although in actual practice a much larger number of subscribers would be served by server 110 and/or subscriber DB 120.

FIG. 1 illustrates that server 110 and/or subscriber DB are in communication with multiple calendar platforms. Three calendar platforms 130; 132 and 134 are depicted for simplicity of presentation although a larger (or smaller) number can be handled in various embodiments of the invention.

FIG. 1 also illustrates that some subscribers belong to institutions. Institutions in this context include corporate entities, governmental agencies, schools, universities and any other legal entity with multiple employees and/or computer users. Each institution typically provides a single calendar platform for all of its employees and/or computer users. In the past, this has resulted in many desirable calendar platform features being available only for employees of a same institution. Two institutions 126a and 126b are depicted for simplicity of presentation although a larger (or smaller) number can be handled in various embodiments of the invention. It is noted that employees of an institution (e.g. 124d; 124e and 124f) often maintain additional electronic calendars outside the institution. These additional calendars may be on a same, or a different calendar platform as that provided by the institution.

In the depicted exemplary embodiment, subscribers 122a; 122b and 122c are unregistered subscribers and subscribers 124a; 124b; 124c; 124d; 124e and 124f are registered subscribers. Subscribers 124d; 124e and 124f may be registered, as a result of an institutional registration from institution 126a. In contrast, institution 126b has no institutional registration and subscribers 122b and 122c are unregistered.

In some embodiments, unregistered subscribers are passive users of the system that receive information and/or meeting requests and/or scheduling announcements but do not actively issue meeting requests to the system. Alternatively or additionally, in some embodiments registered subscribers are active users of the system capable of issuing meeting requests to the system as well as receiving information and/or meeting requests and/or scheduling announcements from the system. In some exemplary embodiments of the invention, registered subscribers install dedicated software on one or more of their user client devices. Alternatively or additionally, in some embodiments unregistered subscribers do not install any dedicated software on their user client devices. According to various exemplary embodiments of the invention subscribers are identified by the system according to one or more e-mail addresses and/or one or more telephone numbers.

In some exemplary embodiments of system 100, server 110 includes a travel module in communication with database 120. Travel module 112 manages travel to and from meetings in calendars of at least some of the subscribers in database 120. According to various exemplary embodiments of the invention module 120 issues a warning and/or re-schedules a meeting if there is insufficient travel time between two meetings at different locations on a calendar of a single subscriber.

### Exemplary Cross Platform System

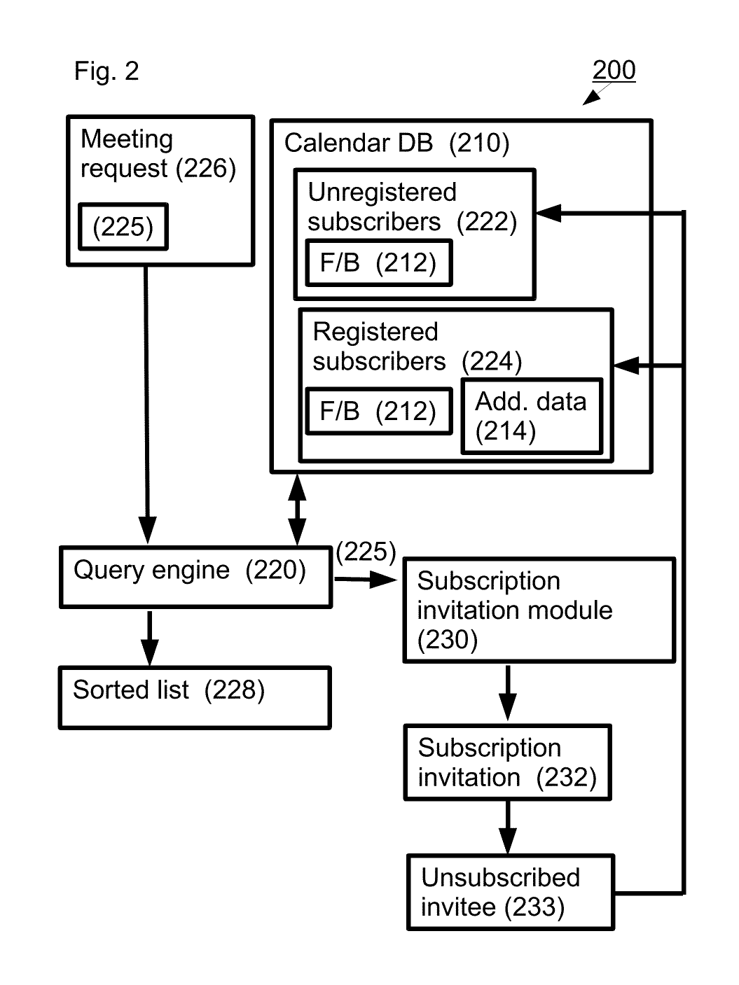

FIG. 2 is a simplified schematic diagram of another calendar system according to some exemplary embodiments of the invention indicated generally as 200. Depicted exemplary system 200 facilitates cross platform event scheduling among subscribers.

Depicted exemplary system 200 includes a calendar database 210 storing free/busy status 212 for time slots in calendars of subscribers 222 and/or 224 using different electronic calendar platforms (e.g. 130 and/or 132 and/or 134 in FIG. 1) and a query engine 220 adapted to receive a meeting request including 226 a time definition and a list of invitees 225 comprising subscribers using different electronic calendar platforms and provide a sorted list 228 of time slots available for the requested meeting. For purposes of system 200, list of invitees 225 includes the person issuing request 226.

Each subscriber 224 and/or 222 is identified by one or more e-mail addresses and/or one or more telephone numbers. According to various exemplary embodiments of the invention list 228 is sorted in different ways (e.g. closest available time slot first and/or time slots with smallest number of invitee conflicts first)

In some embodiments, system 200 serves at least some subscribers without the at least some subscribers installing any software on their user client devices to supplement their electronic calendar platforms. For example, in some embodiments, unregistered subscribers 222 do not install any software on their user client devices. Alternatively or additionally, in some embodiments registered subscribers 224 belonging to an institution with an institutional registration do not install any software on their user client devices. In some embodiments, the institution installs software on a local calendar server to provide registered subscribers 224 with these features. See, for example FIG. 1: subscribers 124d; 124e and 124f registered as a result of an institutional registration from institution 126a.

In some exemplary embodiments of the invention, system 200 includes a subscription invitation module 230 adapted to identify one or more invitees 225 in the invitee list not among the subscribers and issue a subscription invitation 232 to any unsubscribed invitees 233 in the list of invitees 225. According to various exemplary embodiments of the invention the invitation is issued via e-mail and/or via SMS (small message service). Alternatively or additionally, in some embodiments the invitation offers the invitee the opportunity to become a registered subscriber 224 and/or an unregistered subscriber 222.

In the depicted exemplary embodiment, calendar database 210 includes only free/busy status 212 for time slots in calendars of subscribers 222 that are un-registered and free/busy status 212 for time slots in calendars and additional data 214 for subscribers that are registered. According to various exemplary embodiments of the invention additional data 214 includes location (for specific time slots and/or default “workday location” and/or default value for “non-workday location” and/or rank (e.g. within an institution) and/or institutional affiliation. In some embodiments, one item of additional data 214 influences another. For example, institutional affiliation determines default “workday location” in some exemplary embodiments.

### Exemplary Location Aware System

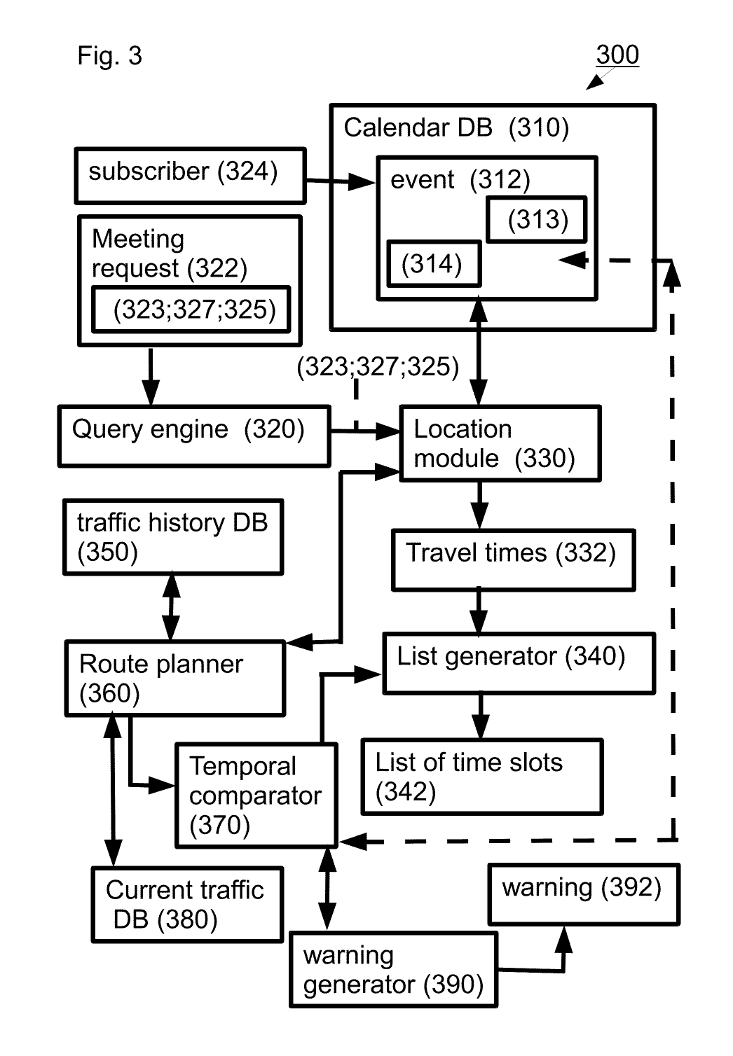

FIG. 3 is a simplified schematic diagram of still another calendar system, indicated generally as 300, according to some exemplary embodiments of the invention.

Depicted exemplary system 300 includes a calendar database 310 adapted to receive calendar events 312 comprising location information 314 for specified time slots 313 from subscribers 324 and a query engine 320 adapted to receive a meeting request 322 including a time definition 323, a location definition 327 and a list of invitees 325 comprising subscribers 324. For purposes of system 300 list of invitees 325 includes the person issuing request 322.

In the depicted exemplary embodiment query engine 320 sends time definition 323, location definition 324 and list of invitees 325 to a location module 330 adapted to consider travel times 332 of one or more invitees to and/or from locations of existing calendar events 312 of subscribers 324 in list of invitees 325 to location 327 defined in meeting request 322. Travel times 332 are provided to a list generator 340 adapted to generate a list of time slots 342 which allow invitees on list 325 from request 322 sufficient time to travel to/from adjacent calendar events 312 on their calendars. According to various exemplary embodiments of the invention the adjacent calendar events are before and/or after the meeting defined in request 322.

In some exemplary embodiments of the invention, system 300 includes a traffic history database 350 storing average travels speeds on roads as a function of time and a route planner 360 configured to estimate a fastest travel time for each invitee in list 325 based upon time definition 323 and the locations of existing calendar events 312 and location 327 specified in meeting request 322. In some embodiments, route planner 360 compares different routes and considers only that route providing the shortest travel time. As indicated by the double headed arrow route planner 360 returns routes to location module 330 in response to queries from that module. In some embodiments, the route providing the shortest travel time is sent to the relevant invitee (e.g. by e-mail) and/or incorporated into a calendar event 312 placed on their calendar when the meeting specified in request 322 is finalized.

Traffic history DB 350 and/or route planner 360 and/or current traffic DB are available commercially. Potential commercial providers of the relevant data and/or services include, but are not limited to WAZE and/or GOOGLE and/or APPLE.

In the depicted exemplary embodiment, system 300 includes a temporal comparator 370 configured to, for each invitee in list 325, calculate the amount of time between time definition 323 in meeting request 322 and an adjacent existing calendar event 312 to produce an available travel time estimate and compare the available travel time estimate to the fastest travel time provided by said route planner 360 and inform list generator 340 whether the time between time 323 in meeting request 322 and existing calendar event 312 is sufficient or insufficient.

The depicted exemplary embodiment also includes a current traffic database 380 monitoring average travels speeds on roads and a warning generator 390 configured to monitor trends in fastest travel time for each invitee in list 325 based upon current invitee locations and location 327 and time definition 323 specified in meeting request 322 and issue a warning 392 to at least one invitee in list 325 if it appears that they will have insufficient travel time. According to various exemplary embodiments of the invention warning 392 delivered by SMS and/or e-mail and/or as a pop up notification on a user client device belonging to the relevant invitee. In some embodiments, warning 392 indicates that the recipient should leave an event 312 before the meeting detailed in request 322 early in order to arrive at the meeting detailed in request 322 on time. In some embodiments, warning 392 indicates that the recipient should leave the meeting detailed in request 322 early in order to arrive at a subsequent event 312 on time.

In some exemplary embodiments of the invention, not all of subscribers 324 and/or invitees in list 325 use a same electronic calendar platform.

### Exemplary Flexible Time Definition System

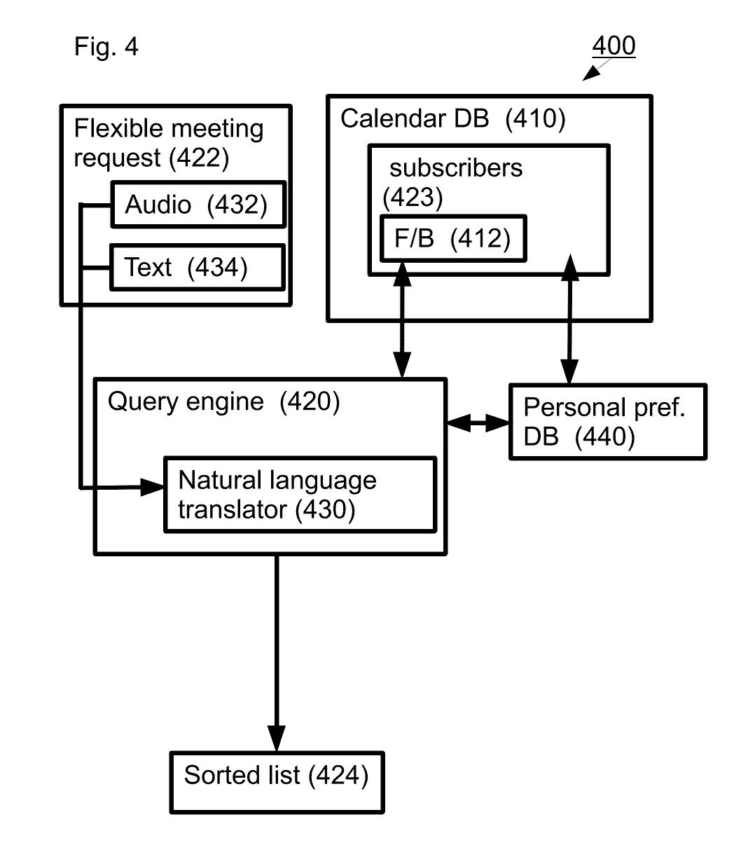

FIG. 4 is a simplified schematic diagram of yet another calendar system, indicated generally as 400. System 400 permits a meeting organizer to search for an available time slot by specifying a flexible definition for the time of the desired meeting.

Depicted exemplary system 400 includes a calendar database 410 storing free/busy status 412 for time slots in calendars of subscribers 423 and a query engine 420 adapted to receive a flexible meeting request 422 including a meeting length, starting time range for hours within a day, and time range in days and a list of invitees and provide a sorted list 424 of time slots complying with conditions of request 422.

In the depicted exemplary embodiment, system 400 includes a natural language translator 430 adapted to translate words defining starting time range for hours within a day, and time range in days into numerical values. In some embodiments, natural language translator 430 accepts an audio input 432. For example, in some embodiments audio input 432 is a recorded command stored on a smart phone and sent as MMS (multimedia service) message or as an e-mail attachment to translator 430. Alternatively or additionally, in some embodiments natural language translator 430 accepts a text input 434. For example, in some embodiments text input 434 is a command sent from a smart phone as SMS and/or email or from computer as e-mail.

In some embodiments, audio 432 and/or text 434 inputs are sent to translator 430 using a communication channel within system 400.

In the depicted exemplary embodiment, system 400 includes a personal preferences database 440 storing scheduling preferences of subscribers. Although personal preferences DB is depicted as a separate item here for clarity, individual personal preferences are a type of additional data 214 (FIG. 2) associated with some system subscribers. According to exemplary embodiments which include DB 440, query engine 420 imposes personal preferences of invitees specified in request 422 as additional conditions upon meeting request 422. For example, subscriber 423 Joe indicated no meetings before 11 AM at least two days a week, but not two consecutive days as a personal preference in DB 440. Subscriber 423 Beth indicated a need to leave by 14:30 on Tuesday or Wednesday the first week of every month in DB 440. If request 422 indicates Beth and/or Joe as invitees, one or both of these personal preferences become additional limitations on meeting request 422. It is important to note that preferences stored at 440 are specific to a subscriber 423, as opposed to a meeting request 422.

In some embodiments, database 440 is adapted to indicate each personal preference as flexible or inflexible. For example, in some embodiments subscribers rank each personal preference according to the number of exceptions to the rule they are willing to tolerate within a defined time period (e.g. week; month or year). An indication of zero specifies complete inflexibility.

In some embodiments, query engine 420 is adapted to accept additional constraints as part of meeting request 422. As an example of an additional constraint, the person issuing request 422 for “Lunch with Bob and Barb” might indicate, “Do not schedule this meeting on a day when I have another meeting with “Lunch” or “Dinner” in the title.” as an additional constraint.

In some exemplary embodiments of the invention, not all of subscribers 423 and/or invitees specified in request 422 use a same electronic calendar platform.

### Exemplary “Ripple Effect” Re-Scheduling

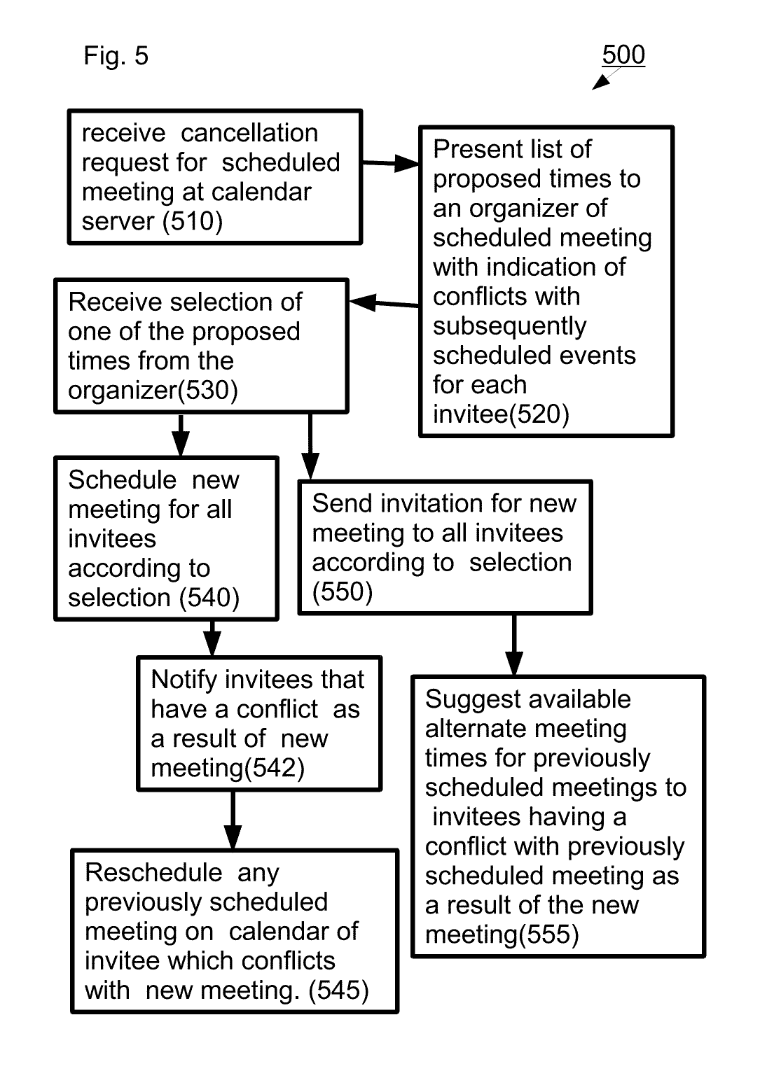

FIG. 5 is a simplified flow diagram of a method, indicated generally as 500, according to some exemplary embodiments of the invention. Depicted exemplary method 500 handles rescheduling of meetings and/or reduces conflicts between meetings for various meeting invitees.

Depicted exemplary method 500 includes receiving 510 a cancellation request for a scheduled meeting at a calendar server and presenting 520 a list of originally proposed times or new proposed times to an organizer of said scheduled meeting with indication of conflicts with other events (e.g. subsequently scheduled) for each invitee and receiving 530 a selection of one of said proposed times from said organizer. In some embodiments, the list of proposed times presented (520) is the original list used by the meeting organizer when scheduling the meeting (See, for example 228 in FIG. 2 and/or 342 in FIG. 3 and/or 424 in FIG. 4 and accompanying text). In other exemplary embodiments of the invention, the list of proposed times presented (520) is a new list generated by a system as described above in response to a new meeting request issued by the meeting organizer (See, for example 226/228 in FIG. 2 and/or 322/342 in FIG. 3 and/or 422/424 in FIG. 4 and accompanying text).

In some exemplary embodiments of the invention, method 500 includes scheduling 540 a new meeting for all invitees according to the selection made at 530 and notifying 542 any invitees that have a conflict with one or more previously scheduled meetings as a result of the new meeting.

In some embodiment of depicted method 500, the method includes rescheduling 545 any previously scheduled meeting on the calendar of an invitee which conflicts with the new meeting. The sequence of events 540/542/545 results in generation of new cancellation requests which are in turn, received 510 at the calendar server. As these cancellation requests pertain to events that are further and further in the future, the number of new conflicts created by each round of rescheduling 545 decreases in a manner analogous to ripples in water radiating outwards. Alternatively or additionally, these re-scheduled events can be viewed as permutations of existing meetings which were agreed upon by the meeting organizers and attendees.

According to these embodiments, meetings which were scheduled by attendees since the original scheduling occurred are automatically rescheduled to accommodate a new time selected by the meeting organizer.

In some embodiments, re-scheduling 545 is available only for registered subscribers and/or does not affect non-registered subscribers. In some embodiments, non-registered subscribers must provide approval for re-scheduling 545 of meetings to which they are invited.

In other exemplary embodiments of method 500 depicted in the figure, selection of a new time at 530 results in sending 550 an invitation for a new meeting to all invitees according to the selection and suggesting available alternate meeting times for previously scheduled meetings to any invitees that have a conflict with previously scheduled meeting as a result of the new meeting Implementation of these embodiments, contributes to a reduction in the amount of involuntary rescheduling.

In some embodiments, the calendaring system allows organizers within an institution to use embodiments of the 530/540/542 type for meetings at which all invitees are of a lower rank than their own within the institution. Alternatively or additionally, in some embodiments the calendaring system requires organizers within an institution to use embodiments of the 530/550/555 type for meetings at which at least one invitees is of a higher rank than their own within the institution. According to these embodiments, rank within the organization is associated with each system subscriber as additional data 214 (FIG. 2).

In some embodiments, receiving 530 of a proposed time from a meeting organizer causes conflicts during initial scheduling of a meeting. This is more likely to occur when the meeting request (226 in FIG. 2 and/or 322 in FIG. 3 and/or 422 in FIG. 4) specifies a large number of invitees and/or a time that is in the near future and/or a time that is narrowly defined and/or a long meeting length (e. g. 4 or 6 or 8 hours). In these cases the list (228 in FIG. 2 and/or 342 in FIG. 3 and/or 424 in FIG. 4) may not include any time slots that do not create conflicts for one or more invitees. When this occurs, the system implements solutions of the 530/540/542 type and/or of the 530/550/555 type as described above.

### Exemplary Erratic Rules Methods

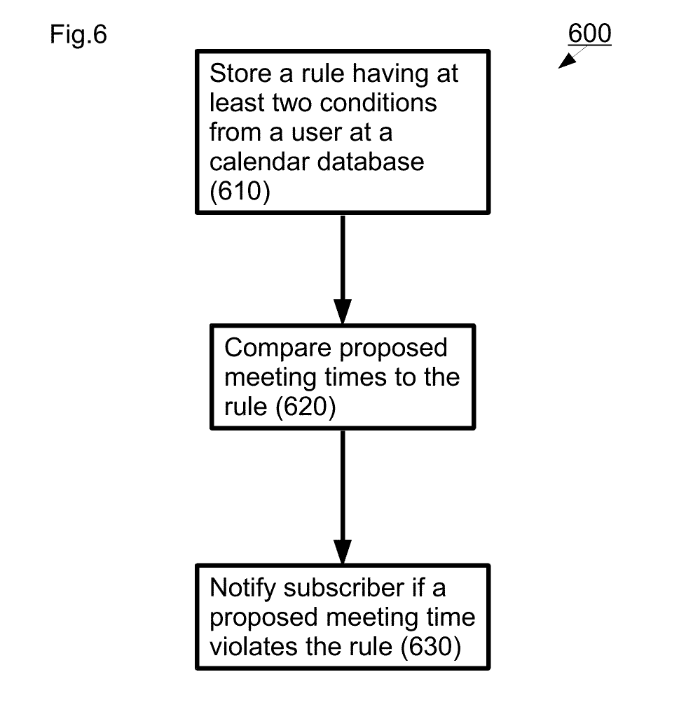

FIG. 6 is a simplified flow diagram of a method for implementing multi-conditional rules in a calendaring system, indicated generally as 600, according to some exemplary embodiments of the invention. Depicted exemplary method 600 includes storing 610 a rule having at least two conditions from a subscriber at a calendar database. According to various exemplary embodiments of the invention this storage occurs, for example, as additional data 214 of a subscriber 424 (FIG. 2) and/or at personal preferences DB 440 (FIG. 4).

Depicted exemplary method 600 includes comparing 620 proposed meeting times to the rule and notifying 630 the subscriber if a proposed meeting time violates the rule.

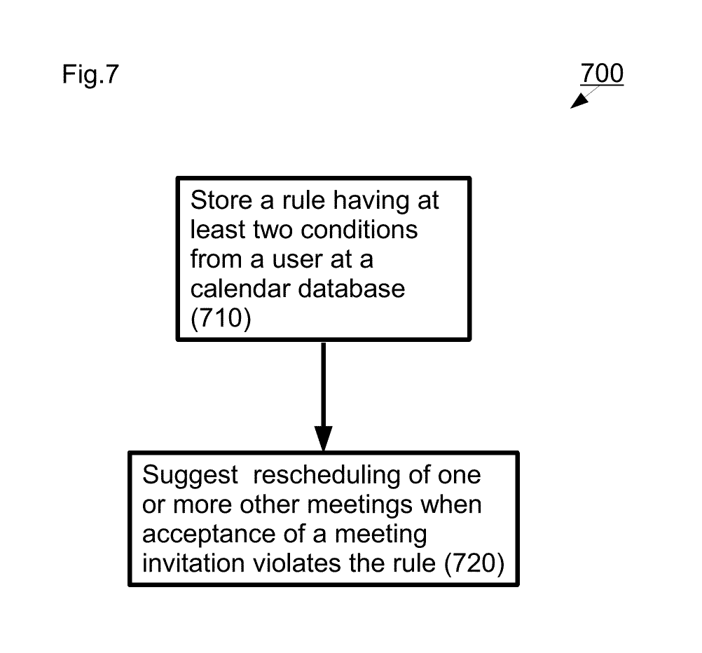

FIG. 7 is a simplified flow diagram of another method for implementing multi-conditional rules in a calendaring system, indicated generally as 700, according to some exemplary embodiments of the invention. Depicted Exemplary method 700 includes storing 710 a rule having at least two conditions from a subscriber at a calendar database (See, for example, additional data 214 (FIG. 2) and/or DB 440 (FIG. 4) suggesting 720 rescheduling of one or more other meetings when acceptance of a meeting invitation violates the rule.

Methods 600 and 700 are primarily relevant to systems where additional data 214 (FIG. 2) and/or DB 440 are treated as subservient to conditions defined by a meeting request. In systems where additional data 214 (FIG. 2) and/or DB 440 are treated as necessary conditions of each individual meeting request, conflicts are less likely to arise.

Methods 600 and 700 are also relevant to meeting requests issued by a rule owner. It is entirely possible that a subscriber will define a rule and then pick a time slot from a sorted list that creates a violation of their own rule.

### Non-Human Invitees

As indicated hereinabove, some meeting requests specify invitees that are resources rather than people. Resources do not actually operate user client devices with electronic calendars. However, the calendar servers of the various systems and methods described hereinabove are designed and configured to maintain calendars for each resource. In some embodiments, this is done by making each resource a subscriber sharing their free/busy status. As with other subscribers, each resource is associate with one or more e-mail addresses and/or one or more telephone numbers. In some embodiments, resources are set up to agree to any meeting request, or to any meeting request for which there is no conflicting event. Alternatively or additionally, calendar servers of the various systems and methods described hereinabove issue lists and/or reminders to relevant personnel. For example, schedules of rooms/times where refreshments are to be served are sent to a catering manager and schedules of rooms/times where presentation equipment is needed may be sent to technology support personnel.

### Exemplary Personal Preferences Scenario

As an example, consider an employee of GOOGLE that lives in the Tel Aviv area and works at GOOGLE offices in Tel Aviv. However, GOOGLE also maintains offices in Haifa and this employee is required to meet with GOOGLE employees from Haifa as part of his duties.

Roundtrip travel between Tel Aviv and Haifa takes 2 to 4 hours depending on travel conditions.

The exemplary employee might set up the following personal preferences in DB 440 (FIG. 4) and/or as additional data 214 (FIG. 2):

“Schedule no more than three trips to Haifa per month.” Implementation of that rule leads to a situation in which six meetings in Haifa are scheduled on three consecutive days in one week. On one day there are two hours between meetings, on another day there are four hours between meetings and on the third day there are six hours between meetings. As a result, the employee is exhausted and his productivity for the week is low.

The exemplary employee, based upon his experience adds several additional personal preferences:

“Never schedule more than two trips to Haifa in one workweek.”; and

“Always allow at least three days between trips to Haifa.”; and

“Never schedule more than one hour free between two meetings during a same trip to Haifa”.

As a result, the employee's travel experience becomes less grueling and his productivity increases.

### Exemplary Use of Boolean Logic

In some embodiments, meeting requests and/or personal preference rules include Boolean operators (e.g. and; or; always; never; if/then; if and only if).

For example in some embodiments invitee list 225 of meeting request 226 is in the form of:

Bob J. and (Janet W. or William B.) and [(Alex R. and Wanda K.) or (Robert A. and Mike L.)];

or in the form of ;

Bob J. and (Janet W. if and only if William B. is not available) and [two of: Alex R.; Wanda K.; Robert A.; Mike L.];

Alternatively or additionally, in some embodiments invitee additional data 214 for a registered subscriber 224 includes a multi-part rule in the form of:

[(i) arrive after 10:30 two times/week and (ii) leave by 16:30 one time per week] wherein [(i) and (ii) never occur on the same day];

or in the form of:

(i) arrive after 10:30 two times/week and allow up to one exception to (i) every six weeks.

### Exemplary Use of Multiple Identifiers for a Single Subscriber

In some exemplary embodiments of the invention, a single subscriber is associated with more than one or more than one e-mail addresses and/or with one or more telephone numbers. For example, some people keep a “work calendar” in a calendar platform associated with a work e-mail address and a “personal calendar” in a calendar platform associated with a different e-mail address. In some embodiments, such a person appears to the system as a registered subscriber 224 (FIG. 2) with respect to their work calendar and an unregistered subscriber (222) with respect to their personal calendar. Such users may perceive this as an advantage because the institution which employs them will have access only to free/busy status 212 for events in their personal calendar and/or because (depending on system configuration) such an arrangement may block undesired re-scheduling of non-work events.

### Exemplary Advantages

The various systems and methods described above offer numerous real world advantages which extend beyond the operational hardware described.

In some exemplary embodiments of the invention, implementation of systems and/or methods as described above reduces the time demands placed on administrative support personnel for tasks related to scheduling and rescheduling meetings.

In some exemplary embodiments of the invention, implementation of systems and/or methods as described above contributes to a reduction in late arrivals and/or missed meetings due to travel times between meetings at different locations.

In some exemplary embodiments of the invention, implementation of systems and/or methods as described above protects privacy of subscribers.

In some exemplary embodiments of the invention, implementation of systems and/or methods as described above contributes to a reduction in time spent on travel. In some embodiments, the reduction results from consolidation of meetings in proximity to one another on a same day.

### Exemplary Integrated Method

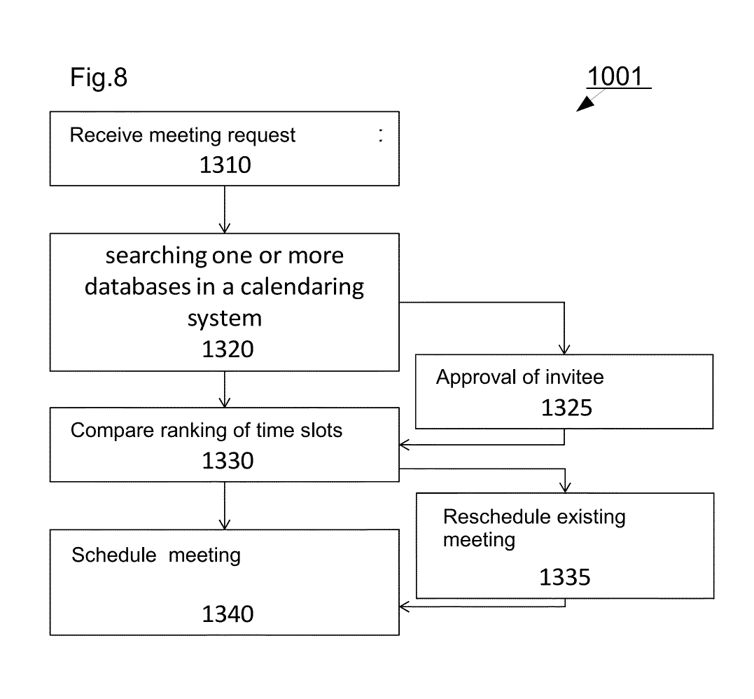

FIG. 8 is a simplified flow diagram of a method according to some exemplary embodiments of the invention indicated generally as 1001.

Although the method of FIG. 8 is described in conjunction with the various system representations set forth herein, persons skilled in the art will understand that any system performs a method which is an embodiment of the invention, in any order, falls within the scope of the present invention.

FIG. 8 is a simplified flow diagram illustrating integration of various features described hereinabove in the context of FIGS. 1 to 7.

At 1310 a meeting request is received. According to various exemplary embodiments of the invention the request has one or more different types of information in it (see e.g. 226 in FIG. 2; 322 in FIG. 3; 422 in FIG. 4 and their descriptions).

Depending on the information contained in the request one or more databases (e.g. 120 in FIG. 1 and/or 210 in FIG. 2 and/or 310 in FIG. 3 and/or 410 in FIG. 4) are searched 1320 to produce a comparative ranking 1330 of available time slots which meet the criteria defined in the request received at 1310. For example, if 3 time slots are available for which no invitees have conflicts, the highest ranking time slot is the one where all invitees have at least a one hour buffer in terms of travel time (see FIG. 3 and accompanying description). As another example, if no time slots exist for which no invitees have a conflict, those time slots where only one invitee has a conflict are ranked highest at 1330. Alternatively or additionally, among time slots where only one invitee has a conflict those slots where the conflict is with another meeting of an “optional participant” are ranked higher than those where the conflict is with another meeting of a “required participant”.

In some embodiments, each invitee indicated in the meeting request received at 1310 receives a meeting invitation and approves 1325 attendance.

At 1330 a comparison is conducted between the rank of the received rank calendar event and, if any, existence event or events at the time slots. Once the meeting organizer that issued the request (1310) selects from among the time slots presented at 1330, the meeting is scheduled 1340. If needed, the system conducts rescheduling 1335 of existing meetings to eliminate conflicts at the selected time slot for one or more invitees.

### Exemplary User Interfaces

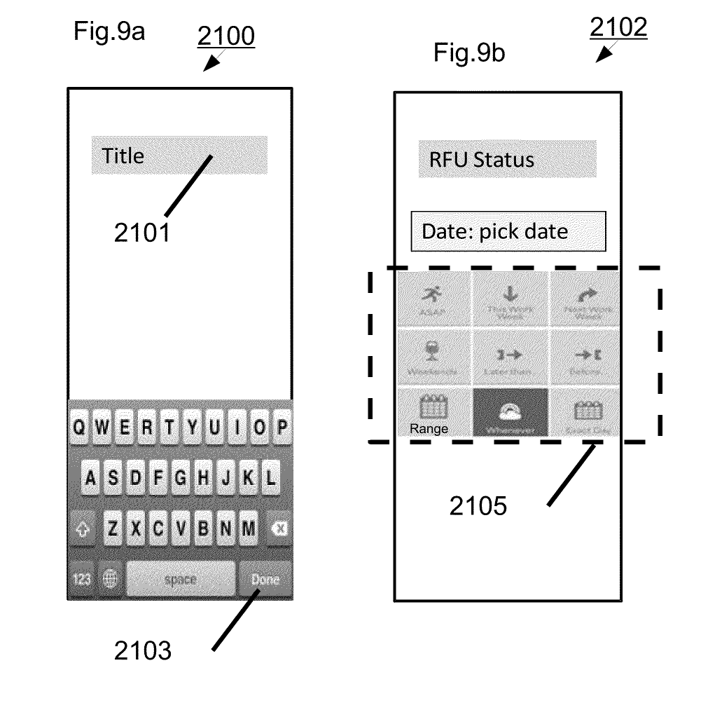

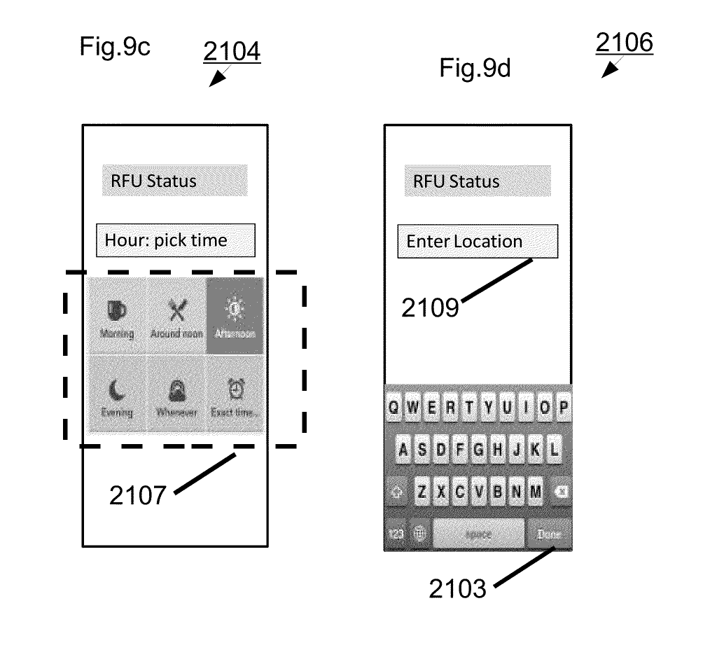

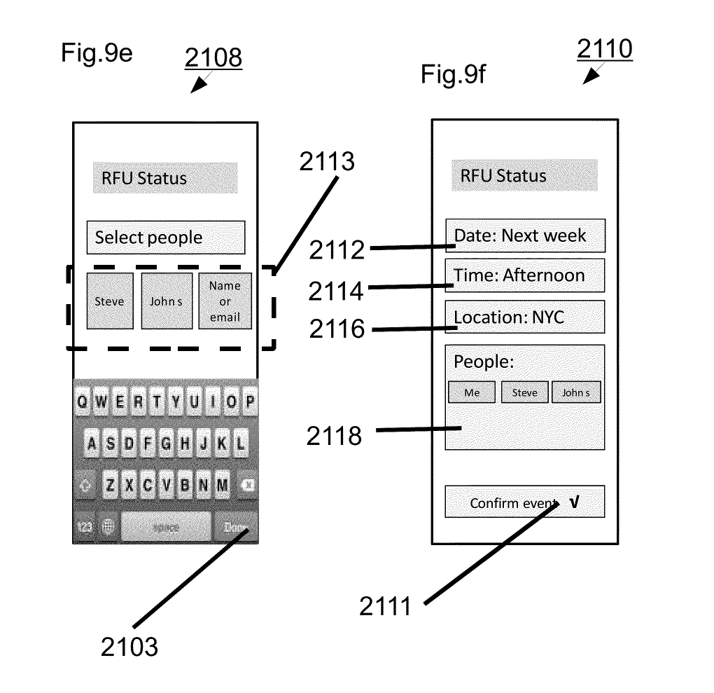

FIGS. 9a, 9b, 9c, 9d, 9e and 9f depict layouts of exemplary user interfaces for creating calendar events according to various exemplary embodiments of the invention indicated generally as 2100; 2102; 2104; 2106; 2108 and 2110 respectively. These interfaces are useful in generating meeting requests (e.g. 226 in FIG. 2; 322 in FIG. 3; 422 in FIG. 4). While these user interfaces are examples of how to implement scheduling of calendar events according to various exemplary embodiments of the invention as described above, other interfaces with similar functionalities can be substituted to create additional embodiments. The interfaces are depicted on smart phone devices with touch screens but can also be implemented on tablet devices and/or on non-touch screen user clients which use a cursor. Alternatively or additionally, although the data input screens are described as being presented in a certain order, other orders of screen presentation are feasible. One common denominator of these interfaces is that they present popular choices in a way that contributes to a reduction in data entry effort.

FIG. 9a shows an explary initial screen for preparing a meeting request for a new meeting. In the depicted exemplary embodiment, the title is entered in a free text field 2101 using a keyboard or microphone. When the title is complete the “done” button 2103 is pressed. In some embodiments, entry of meeting length is conducted on this screen using a pull down menu or scroll wheel (not depicted).

FIG. 9b shows an exemplary subsequent screen for entering a flexible date definition. In some embodiments, flexibility in date definition contributes to ease in scheduling a meeting. This may be especially true as the number of invitees increases and/or the proposed new meeting is soon. In the depicted exemplary embodiment, a group of buttons 2105 allow the user to select a range of dates with a single button press. The “select week”, “range” and “exact dates” buttons will bring up a calendar interface that allows manual input of a selected week or range of dates or exact date. In some embodiments, once date entry is complete, the next screen appears automatically.

FIG. 9c shows an exemplary subsequent screen for entering a flexible time definition. In some embodiments, flexibility in time definition contributes to ease in scheduling a meeting as in the context of date definition. In the depicted exemplary embodiment, a group of buttons 2107 allow the user to select a portion of the day with a single button press. Each button of buttons 2107 defines a time range. For example, Morning is defined as 9 to 12 in some embodiments and “around noon” is defined as 11 am to 1 pm. In some embodiments, these buttons are preprogrammed with default values. If a user changes the default value, that change is operative only on the one or more user client devices belonging to that user. Thus, the change in definition will affect only meeting requests originating from the user that made the change. The “exact times” button will bring up clock interface (e.g. scroll wheels) that allows manual input of a start time or range of start times. In some embodiments, once time entry is complete, the next screen appears automatically.

FIG. 9d shows an exemplary screen for designation of meeting location featuring a free text field 2109. In other exemplary embodiments of the invention, buttons are provided for common locations (e.g. conference room, my office). Since one of the functions of location is to estimate required travel times for external invitees, precise locations contribute to accuracy. For example, “Allenby St. 210; Tel Aviv” is more useful than “Tel Aviv”. In some embodiments, the system assigns a default location (e.g. corporate headquarters of the meeting organizer) if no location is defined or if a location is defined as a room designation only. In some embodiments, once location entry is complete, the next screen appears automatically.

FIG. 9e shows an exemplary screen for designation of invitees featuring collection of buttons 2113. In some embodiments, the buttons are specific to likely invitees. In some embodiments, the system generates a list of likely invitees based on past meetings with similar titles. In the depicted exemplary embodiment, the “name or e-mail” button opens a dialog box with a free text entry field. When the invitee list is complete the “done” button 2103 is pressed.

FIG. 9f shows an exemplary screen for issue of a meeting invitation once data entry is complete. The depicted interface screen includes fields for flexible date definition 2112, flexible time definition 2114, location 2116 and invitee list 2118. The organizer reviews the list to make sure all the details are correct and complete and then presses the “confirm event” button 2111 to issue a meeting request (e.g. 226 in FIG. 2; 322 in FIG. 3; 422 in FIG. 4) to the system. If review suggests that some of the information is incorrect and/or incompletes, a tap on the relevant field brings up the relevant data entry screen.

It is expected that during the life of this patent many new electronic calendar platforms and many new types of user client devices will be developed and the scope of the invention is intended to include all such new technologies a priori.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Specifically, a variety of numerical indicators have been utilized. It should be understood that these numerical indicators could vary even further based upon a variety of engineering principles, materials, intended use and designs incorporated into the various embodiments of the invention. Additionally, components and/or actions ascribed to exemplary embodiments of the invention and depicted as a single unit may be divided into subunits. Conversely, components and/or actions ascribed to exemplary embodiments of the invention and depicted as sub-units/individual actions may be combined into a single unit/action with the described/depicted function.

Alternatively, or additionally, features used to describe a method can be used to characterize an apparatus and features used to describe an apparatus can be used to characterize a method.

It should be further understood that the individual features described hereinabove can be combined in all possible combinations and sub-combinations to produce additional embodiments of the invention. The examples given above are exemplary in nature and are not intended to limit the scope of the invention which is defined solely by the following claims.

Each recitation of an embodiment of the invention that includes a specific feature, part, component, module or process is an explicit statement that additional embodiments of the invention not including the recited feature, part, component, module or process exist.

Specifically, the invention has been described in the context of electronic calendars but might also be used logistics scheduling in other contexts (e.g.

management of storage space in freight transportation vehicles and/or containers). All publications, references, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “include”, and “have” and their conjugates as used herein mean “including but not necessarily limited to”.

1. A system comprising:
(a) a calendar database adapted to receive calendar events comprising location information for specified time slots from subscribers;
(b) a query engine adapted to receive a meeting request including a time definition, a location definition and a list of invitees comprising subscribers; and
(c) a location module adapted to consider travel times of one or more invitees to and/or from locations of existing calendar events to said location; and
(d) a list generator adapted to generate a list of time slots which allow invitees sufficient time to travel to/from adjacent calendar events.

2. A system according to claim 1, comprising:
a traffic history database storing average travels speeds on roads as a function of time; and
a route planner configured to estimate a fastest travel time for each invitee based upon said time definition and said locations of existing calendar events and said location specified in said meeting request.

3. A system according to claim 2, comprising a temporal comparator configured to, for each invitee,
calculate the amount of time between the time definition in said meeting request and an adjacent existing calendar event to produce an available travel time estimate; and
compare the available travel time estimate to said fastest travel time provided by said route planner and inform said list generator whether the time between the meeting request and the existing calendar event is sufficient or insufficient.

4. A system according to claim 1, comprising:
a current traffic database monitoring average travels speeds on roads; and
a warning generator configured to monitor trends in fastest travel time for each invitee based upon current invitee locations and said location and said time definition specified in said meeting request and issue a warning to at least one invitee if it appears that they will have insufficient travel time.

5. A system according to claim 1, wherein not all of said subscribers use a same electronic calendar platform.

6. A system comprising:
(a) a calendar database storing free/busy status for time slots in calendars of subscribers using different electronic calendar platforms; and
(b) a query engine adapted to receive a meeting request including a time definition and a list of invitees comprising subscribers using different electronic calendar platforms and provide a sorted list of time slots available for the requested meeting.

7. A system according to claim 6, serving at least some of said subscribers without said at least some of said subscribers installing any software on their user client devices to supplement their electronic calendar platforms.

8. A system according to claim 6, comprising a subscription invitation module adapted to identify one or more invitees in said list not among said subscribers and issue a subscription invitation to said one or more invitees in said list not among said subscribers.

9. A system according to claim 6, wherein said calendar database includes:
only free/busy status for time slots in calendars of subscribers that are un-registered; and
free/busy status for time slots in calendars and additional data for subscribers that are registered.

10. A system comprising:
(a) a calendar database storing free/busy status for time slots in calendars of subscribers; and
(b) a query engine adapted to receive a flexible meeting request including a meeting length, starting time range for hours within a day, and time range in days and a list of invitees and provide a sorted list of time slots complying with the request conditions.

11. A system according to claim 10, comprising a natural language translator adapted to translate words defining starting time range for hours within a day, and time range in days into numerical values.

12. A system according to claim 11, wherein said natural language translator accepts an audio input.

13. A system according to claim 11, wherein said natural language translator accepts a text input.

14. A system according to claim 10, comprising a personal preferences database storing scheduling preferences of subscribers, wherein said query engine imposes personal preferences of invitees as additional conditions upon said meeting request.

15. A system according to claim 14, wherein said database is adapted to indicate each personal preference as flexible or inflexible.

16. A system according to claim 14, wherein said query engine is adapted to accept additional constraints as part of said meeting request.

17. A system according to claim 10, wherein not all of said invitees use a same electronic calendar platform.

18-23. (canceled)
